(19) United States
(12) Patent Application Publication
(10) Pub. No.: US 2021/0106056 A1
(43) Pub. Date: Apr. 15, 2021

(54) ATOMIZATION CORE

(71) Applicant: Tuanfang LIU, Shenzhen (CN)

(72) Inventor: Tuanfang LIU, Shenzhen (CN)

(21) Appl. No.: 17/020,798

(22) Filed: Sep. 14, 2020

(30) Foreign Application Priority Data
Oct. 10, 2019 (CN) 201921688336.6
Dec. 19, 2019 (CN) 201911321976.8

(51) Int. Cl. A24F 40/46; H05B 3/16

(52) U.S. Cl. CPC A24F 40/46; H05B 2203/007; H05B 3/16

(57) ABSTRACT

An atomization core, including a ceramic heater and a plurality of heating wires. The ceramic heater is cylindrical and includes a first heating element and a second heating element disposed side by side and electrically connected in parallel. The first heating element and the second heating element include a first axial center through hole and a second axial center through hole, respectively. The ceramic heater includes a bottom wall, and the plurality of heating wires is in parallel disposed on the bottom wall and extends along an axial direction of the ceramic heater.

### CROSS-REFERENCE TO RELATED APPLICATIONS

Pursuant to 35 U.S.C. § 119 and the Paris Convention Treaty, this application claims foreign priority to Chinese Patent Application No. 201911321976.8 filed Dec. 19, 2019, and to Chinese Patent Application No. 201921688336.6 filed Oct. 10, 2019. The contents of all of the aforementioned applications, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to an atomization core.

A conventional atomization core comprises one heating element.

### SUMMARY

The disclosure provides an atomization core comprising a ceramic heater and a plurality of heating wires; the ceramic heater is cylindrical and comprises a first heating element and a second heating element disposed side by side and electrically connected in parallel; the first heating element and the second heating element comprise a first axial center through hole and a second axial center through hole, respectively; the ceramic heater comprises a bottom wall, and the plurality of heating wires is in parallel with each other, is disposed on the bottom wall and extends along the axial direction of the ceramic heater.

The following advantages are associated with the atomization core of the disclosure:

1. When used in an atomizer, with low resistance value and high heating power, the atomization core can vaporize much more smoke materials and produce more vapor.

2. The atomization core is adapted to a variety of smoke materials, has long service life, quick temperature rise, no explosion, and thus can protect the quality of the smoke material from being damaged.

### BRIEF DESCRIPTION OF THE DRAWINGS

FIG. 1 is a schematic diagram of an atomization core according to one embodiment of the disclosure;

FIG. 2 is a schematic diagram of an atomization core according to another embodiment of the disclosure; and

FIG. 3 is a sectional view of an atomization core according to one embodiment of the disclosure.

### DETAILED DESCRIPTION

To further illustrate, embodiments detailing an atomization core are described below. It should be noted that the following embodiments are intended to describe and not to limit the disclosure.

Smoke materials refer to smoke oil, tobacco, tobacco and other materials used to produce smoke.

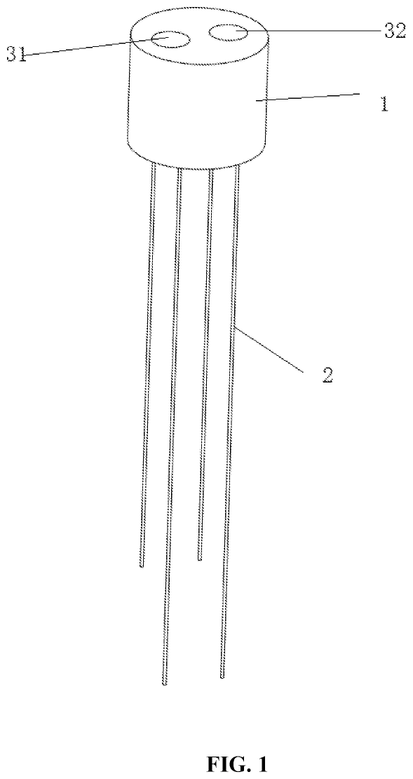

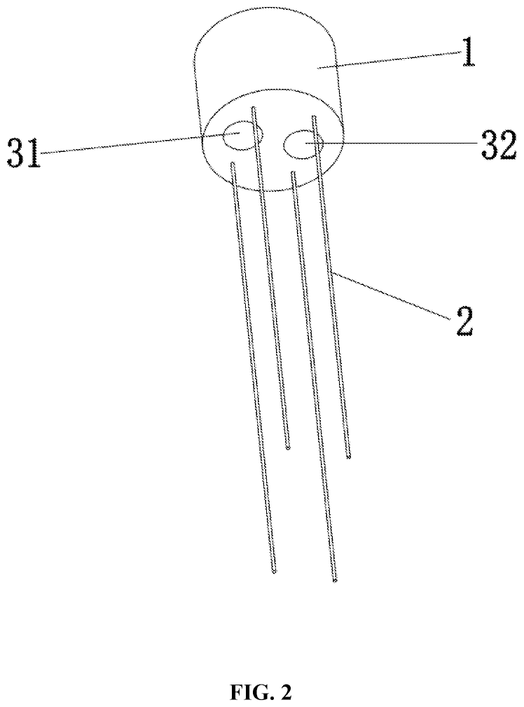

As shown in FIGS. 1-3, an atomization core comprises a ceramic heater 1 and a plurality of heating wires 2. The ceramic heater is cylindrical and comprises a first heating element and a second heating element disposed side by side and electrically connected in parallel. The first heating element and the second heating element comprise a first axial center through hole 31 and a second axial center through hole 32, respectively. The ceramic heater 1 comprises a bottom wall, and the plurality of heating wires 2 are in parallel disposed on the bottom wall and extends along the axial direction of the ceramic heater. The plurality of heating wires 2 is parallel to each other.

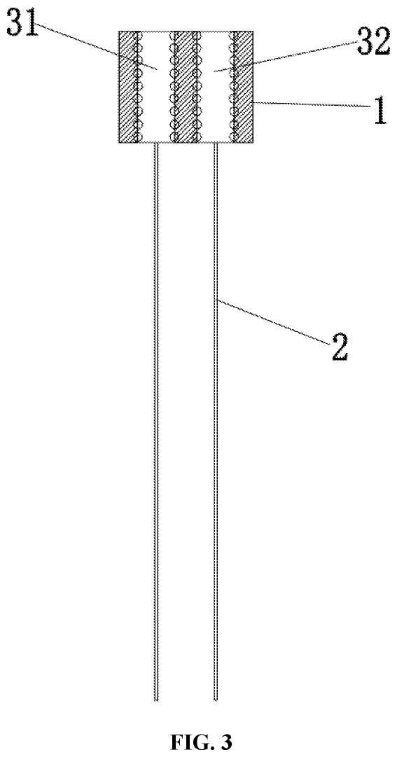

As shown in FIG. 3, the plurality of heating wires each comprises a cut.

In one embodiment, the atomization core is a cylindrical structure and comprises a ceramic heater comprising two ceramic heating elements stacked upon one another and connected in parallel. Each ceramic heating element comprises an axial center through hole. Compared with a conventional atomization core, the ceramic atomization core has a large longitudinal heating area, large liquid absorption, and the smoke material is heated more fully and evenly. When used in an atomizer, with low resistance value and high heating power, the atomization core can vaporize much more smoke materials and produce more vapor. The atomization core is adapted to a variety of smoke materials, has long service life, quick temperature rise, no explosion, and thus can protect the quality of the smoke material from being damaged.

It will be obvious to those skilled in the art that changes and modifications may be made, and therefore, the aim in the appended claims is to cover all such changes and modifications.

What is claimed is:

1. An atomization core, comprising a ceramic heater and a plurality of heating wires; wherein the ceramic heater is cylindrical and comprises a first heating element and a second heating element disposed side by side and electrically connected in parallel; the first heating element comprise a first axial center through hole and the second heating element comprises a second axial center through hole; the ceramic heater comprises a bottom wall, and the plurality of heating wires is in parallel disposed on the bottom wall and extends along an axial direction of the ceramic heater.
